(19) United States
(12) Patent Application Publication
(10) Pub. No.: US 2022/0207640 A1
(43) Pub. Date: Jun. 30, 2022

(54) COMMUNICATIONS SERVER APPARATUS AND METHOD FOR DERIVING A QUANTUM MODIFIER FOR A TRANSPORT-RELATED SERVICE

(71) Applicant: GRABTAXI HOLDINGS PTE. LTD., Singapore (SG)

(72) Inventors: Xin XU, Singapore (SG); Padarn George WILSON, Singapore (SG); Chao XIE, Singapore (SG); Yang CAO, Singapore (SG); Prashant KUMAR, Singapore (SG)

(21) Appl. No.: 17/610,055

(22) PCT Filed: May 16, 2019
(86) PCT No.: PCT/SG2019/050267

§ 371 Date: Nov. 9, 2021

(51) Int. Cl. G06Q 50/30; G06Q 10/06

(52) U.S. Cl. CPC G06Q 50/30; G06Q 10/063116

(57) ABSTRACT

A communications server apparatus for deriving a quantum modifier for a quantum related to a transportation service, the communications server apparatus comprising a processor and a memory, and being configured, under control of the processor to execute instructions in the memory: to receive user service request data comprising data indicative of a user pick-up location and data indicative of a user drop-off location, to record a user pick-up time and to generate one or more data records comprising: an index idle time data field comprising data indicative of an index idle time at plural notional drop-off locations; and a user drop-off time data field comprising data indicative of a user drop-off time; to retrieve, from a database, data indicative of a service provider's estimated idle time for the user drop-off location at the user drop-off time; to compare the data indicative of the index idle time and the data indicative of the service provider's estimated idle time and generate a comparison result data field comprising data indicative of a comparison result; and to generate, in the one or more data records, a data field comprising quantum modifier data indicative of the quantum modifier based on the data indicative of the comparison result.

### TECHNICAL FIELD

The invention relates generally to the field of communications. One aspect of the invention relates to a communications server apparatus for deriving a quantum modifier for a quantum related to a transportation service. Another aspect of the invention relates to a method, performed in a communications server for deriving a quantum modifier for quantum related to a transportation service. Another aspect of the invention relates to a computer program product comprising instructions therefor. Another aspect of the invention relates to a computer program comprising instructions therefor. Another aspect of the invention relates to a non-transitory storage medium storing instructions therefor. Another aspect of the invention relates to a communications system for deriving a quantum modifier for quantum related to a transportation service.

One aspect of the invention has particular, but not exclusive, application in taxi and ride-hailing.

### BACKGROUND

Currently, assessment of quanta relating to taxi and ride-hailing, such as pricing, is based typically on distance, estimated travel time and demand-supply imbalance. These signals allow determination of quanta, particularly in respect of cost, to recover on-trip resources and maintain passengers' allocation rate.

United States Patent Publication No. 2015248689 discloses systems and methods for providing transportation discounts. A server receives, from a client device of a user, a request for a transportation service. In response, the server identifies that the request relates to a particular characteristic associated with modified pricing. The server then calculates an adjusted price for the transportation service based on the modified pricing associated with the particular characteristic.

However, this document does not consider the proper smooth utilisation of driver resources. Assuming that there are two bookings which have the same pick-up location, the same pick-up time slot, the same estimated travel distance and the same estimated travel time, based on the known booking techniques, these two bookings would be determined to have a similar or identical value. However, the first drop off location for the first booking may be in, say, the central business district (CBD) area, where the service provider can find a job easily after dropping off the passenger. The second drop off location for the second booking may be in the suburbs, where the service provider can expect to find new jobs harder to come by after dropping off the passenger. If a service provider accepts the second booking, he will likely spend more time finding another job after dropping the passenger, while being compensated in the same way as he (or she) would have been if he had accepted the first booking. As such, service providers will generally prefer the first booking, and the allocation rate for bookings similar to the second booking could be very low. This leads to difficulties in driver resource utilisation and may exacerbate mismatches in supply and demand characteristics.

### SUMMARY

Aspects of the invention are as set out in the independent claims. Some optional features are defined in the dependent claims.

Implementation of the techniques disclosed herein may provide significant technical advantages. A component that is presently not directly incorporated into the allocation of transport-related services such as ride-hailing trips is the expected utilisation of service providers depending on drop-off location. In the known techniques, a high utilisation of supply reduces the overall utilisation cost to serve the trip while the converse increases the overall utilisation cost. The techniques disclosed herein may incorporate supply utilisation or opportunity cost into the trip resource allocation. As such, resource allocation may cover not only resources relating to the trip itself, for example the on-trip cost, but may also cover after-trip opportunity (or, rather, potential lost opportunity) considerations which can be caused, for example, by increased idle time after completion of the trip. As such, an overall improvement of service demand load utilisation may be provided in that the “idle time” may be defined as the period of time in which the service provider has no job after dropping off the passenger. That is, the period of time between dropping off the passenger and finding another job. Additionally, the “idle” state may be defined as the state of the service provider when the service provider has not received another job after completing the previous one. Also, for the bookings from the same pick-up location, the bookings with shorter idle time drop-off locations may have a quantum in respect of the service request reduced (for example, the price may be discounted), while the bookings with longer idle time drop off locations may have the quantum increased; for example, the price may be increased. More bookings to areas where shorter idle time are expected to occur and consequently, the network utilisation in the short idle time areas may be improved. Since the network utilisation in these areas improves, service providers can finish more trips within the same period, thereby meaning a potential improvement in demand balancing in these areas. On the other hand, if service providers receive bookings to drop off locations with long idle time, they will be compensated with an increase in the service quantum, for example a higher price. In this way, service providers are incentivised to accept bookings to the long idle time areas and can serve more passengers traveling to these locations. Records relating to recorded idle time at particular locations at particular times of the day may be recorded in, for example, a database. The idle time can be recorded as a time between a driver indicating that he has completed a job—i.e. he has dropped off his passenger in or at a particular geographical location or region—and the driver having a confirmed, received booking for the next job. The data can be derived at the server end from the transmissions received from the driver's device, or the data relating to the idle time can be derived by the driver's device and transmitted to the server end for storage thereat. This historical idle time can be used in calculating the (lost) opportunity cost, as will be described below.

As such, the driver/service provider utilisation may be smoothed and the demand distributions shaped in order to avoid or at least mitigate issues caused by extreme discrepancies in supply-demand imbalance, in the same way that techniques may be provided for, say, electrical supply-load balancing or computer processing load balancing. In at least some implementations, the techniques disclosed herein may provide a way to measure and predict the supply utilisation of service providers using the historical data indicative of service providers' idle time after dropping off passengers. Longer idle times means lower supply utilisation of service providers in a drop-off location. Generally, smaller idle time is preferred.

In at least some implementations, the techniques disclosed herein may provide a method for calculating opportunity cost based on the predicted supply utilisation. Plural notional drop-off locations from a pick-up location are derived, and an index idle time—a type of reference or base idle time quantum—is calculated. The opportunity costs of each booking may be the product of service providers' time value and the difference between the index idle time and the estimated idle time. The “time value” may be a revenue per second value of the service providers from the pick-up location.

In at least some implementations, the techniques disclosed herein may provide a hierarchical model for online real-time idle time prediction, in which the first layer model describes the estimated idle time distribution and the second layer describes how the parameters in the first layer change due to other real time signals. The idle time estimation is based on historical observations and other real time signals may be used to improve the estimation accuracy. The first layer may use a gamma distribution (or some other distributions) to approximate the true idle time distribution. This approximation distribution may not be fixed but may vary over time and space with different parameters. The parameters could be functions of several signals, which may form the second layer model, describing how the parameters would be changed given the signals. The signals can be divided into two categories. The first category is real time signals, e.g. real-time demand, supply, weather and so on. The second category is off-line signals, for example, the idle time estimated with historical idle time records, the latitude and longitude of locations and so on.

In at least some implementations, the techniques disclosed herein allow for derivation of an index idle time and a service provider's estimated idle time using historical data. The techniques disclosed herein may allow for derivation of a quantum modifier in a data record based on the service provider's estimated idle time and index idle time. The service providers' idle time may not be absolute but relative. For example, there may be two bookings to the same long idle-time destination, the pick-up location of the first booking being a central business district (CBD) area, and the pick-up location of the second booking being from a remote area. For a service provider who accepts the first booking (from the CBD where a higher number of jobs are anticipated), an alternative choice may be or may have been to go to short idle time areas. As such, a modifier in the form of a surcharge may be added to the first booking to incentivise the service provider to accept the first booking. For the service provider who accepts the second booking, his alternative bookings may all be towards long idle time areas. As such, a modifier/surcharge may not be added to the second booking.

An ancillary benefit of the disclosed techniques may be to allow guidance to be presented to service providers, in the form of instructions which may be in the form of a heatmap, to find their next job more easily by using the estimated idle time of locations. Regardless of the types of bookings, guidance will be given to service providers by directing them to an area in which the idle times are historically shorter; the service providers will have a better chance of getting a job more quickly. After the service providers drop off passengers, the service providers' app may present a heatmap containing information regarding the historical idle times at different locations. Service providers may have expectations of difficulties in finding their next jobs, and may drive to the locations with relatively lower historical idle times. More detailed instructions on where to find the next job easily according to the place of interest (POI) reminder—a notification concerning places where a high (or higher) number of bookings are taking place, or have taken place—will also be given. It is possible that the heatmap is generated using historical data, perhaps historical data only. Using the techniques disclosed herein, it may also be possible to present a real time forecasted idle time on the heatmap. The forecasted idle time may be based on historical data and real-time signals such as current demand, current supply and so on.

### BRIEF DESCRIPTION OF THE DRAWINGS

The invention will now be described, by way of example only, and with reference to the accompanying drawings in which:

FIG. 1 is a schematic block diagram illustrating an exemplary communications system for deriving a quantum modifier for a quantum related to a transportation service.

FIG. 2a is a schematic block diagram illustrating an example of plural notional drop-off locations from a pick-up location.

FIG. 2b is a schematic block diagram illustrating data fields of the system of FIG. 2a.

FIG. 3 is a schematic block diagram illustrating one or more data records.

FIG. 4 is a flow diagram illustrating a method performed in a communications server apparatus for deriving a quantum modifier for a quantum related to a transportation service.

FIG. 5 is a flow diagram illustrating a method for deriving a quantum modifier for a quantum related to a transportation service.

FIG. 6 is a diagram illustrating how data for deriving a quantum modifier for a quantum related to a transportation service is transferred in an exemplary system.

### DETAILED DESCRIPTION

The techniques described herein are described primarily with reference to use in taxi and ride-hailing, but it will be appreciated that these techniques have a broader reach and cover other types of transportation services, including the transportation of documents and goods.

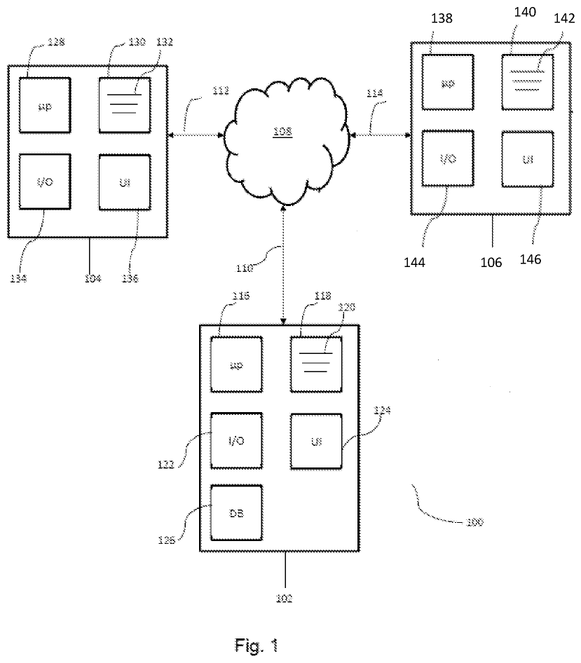

Referring first to FIG. 1, a communications system 100 is illustrated. Communications system 100 comprises communications server apparatus 102, user communications device 104 and service provider communications device 106. These devices are connected in the communications network 108 (for example the Internet) through respective communications links 110, 112, 114 implementing, for example, internet communications protocols. Communications devices 104, 106 may be able to communicate through other communications networks, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. In the example of FIG. 1, communications server apparatus 102 may comprise a number of individual components including, but not limited to, one or more microprocessors 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, computing peripheral devices such as display monitors, computer keyboards and the like. Communications server apparatus 102 also comprises a database 126, the purpose of which will become readily apparent from the following discussion. In this embodiment, database 126 is part of the communications server apparatus 102, however, it should be appreciated that database 126 can be separated from communications server apparatus 102 and database 126 may be connected to the communications server apparatus 102 via communications network 108 or via another communications link (not shown).

User communications device 104 may comprise a number of individual components including, but not limited to, one or more microprocessors 128, a memory 130 (e.g. a volatile memory such as a RAM) for the loading of executable instructions 132, the executable instructions defining the functionality the user communications device 104 carries out under control of the processor 128. User communications device 104 also comprises an input/output module 134 allowing the user communications device 104 to communicate over the communications network 108. User interface 136 is provided for user control. If the user communications device 104 is, say, a smart phone or tablet device, the user interface 136 will have a touch panel display as is prevalent in many smart phone and other handheld devices. Alternatively, if the user communications device is, say, a desktop or laptop computer, the user interface may have, for example, computing peripheral devices such as display monitors, computer keyboards and the like.

Service provider communications device 106 may be, for example, a smart phone or tablet device with the same or a similar hardware architecture to that of user communications device 104. Service provider communications device 106 may comprise a number of individual components including, but not limited to, one or more microprocessors 138, a memory 140 (e.g. a volatile memory such as a RAM) for the loading of executable instructions 142, the executable instructions defining the functionality the service provider communications device 106 carries out under control of the processor 138. Service provider communications device 106 also comprises an input/output module 144 allowing the service provider communications device 106 to communicate over the communications network 108. User interface 146 is provided for user control. If the service provider communications device 106 is, say, a smart phone or tablet device, the user interface 146 will have a touch panel display as is prevalent in many smart phone and other handheld devices. Alternatively, if the user communications device is, say, a desktop or laptop computer, the user interface may have, for example, computing peripheral devices such as display monitors, computer keyboards and the like.

In one embodiment, the service provider communications device 106 is configured to push data representative of the service provider (e.g. service provider identity, location and so on) regularly to the communications server apparatus 102 over communications network 108. In another, the communications server apparatus 102 polls the service provider communications device 106 for information. In either case, the data from the service provider communications device 106 are communicated to the communications server apparatus 102 and stored in relevant locations in the database 126 as historical data. The historical data includes, amongst other things, data indicative of service providers' idle time after dropping off passengers at their drop-off locations. As described in more detail below, historical data in the database 126 may be used for deriving data indicative of a quantum modifier for a quantum related to a transportation service, for example, a price adjustment for the service. Modifiers for other transport service quanta may also be derived using the techniques disclosed herein. For instance, in addition or as an alternative to price adjustment, adjustments to quanta like promotions or incentives may be derived. For trips to short idle times, the communications server apparatus 102 may allocate promotions to passengers. To motivate drivers to accept jobs to areas with longer idle times, communications server apparatus 102 may allocate incentives to the drivers.

Using the collected historical data in database 126, the communications server apparatus 102 is able to predict and derive data such as the service provider's estimated idle time, the service providers' ignore rate to specific pick-drop location pairs and revenue per second for trips from the same pick-up location. Ignore rate and revenue per second (rps) can be calculated with the most recent historical data.

Revenue per second can be defined as the ratio between the trips' basic fares (without any surcharge or discount) and durations. It approximately measures the value of drivers' time. In one exemplary arrangement, the revenue per second and the difference between the index idle time and the expected idle time are multiplied together to get the surcharge or discount.

The ignore rate may be defined as the ratio between the number of times that drivers ignore a certain kind of booking (fixed pick-up location, drop-off location and pick up time) and the total number of broadcasts of such bookings. A high ignore rate can be indicative that drivers do not want to accept this kind of booking due to various factors such as bad traffic, low price and so on. It is possible to determine the trips with high ignore rates. If there would be a calculated discount for this trip (with revenue per second and idle times), the apparatus may be configured so that discounts will not be applied for these trips.

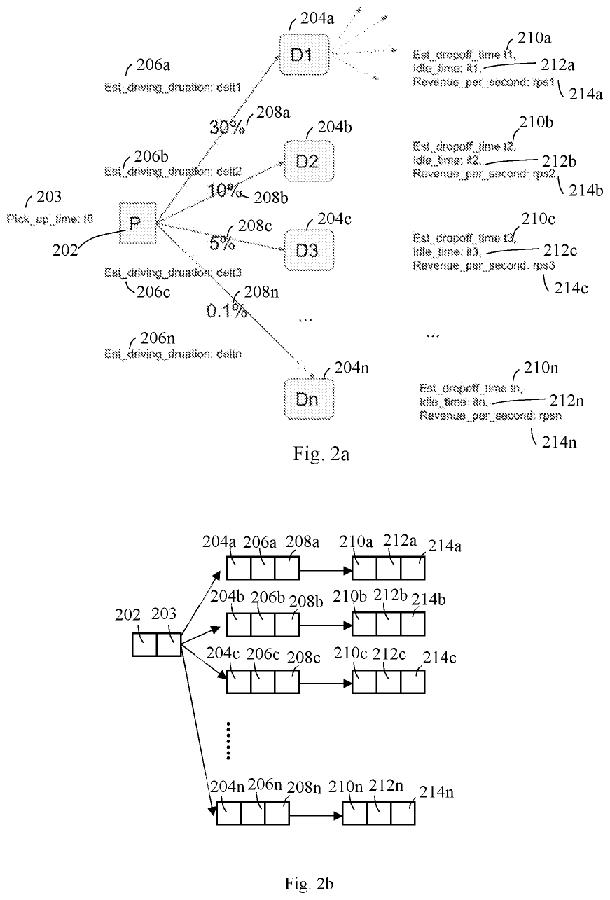

FIG. 2a is a schematic block diagram illustrating a pick-up location 202 for a user (in this example, a rider looking for a car or taxi booking but, as mentioned above, the techniques disclosed herein extend to use in other transport-related services), with an associated pickup time 203 for the user and plural potential drop-off locations 204a, 204b, 204c . . . 204n. The potential drop-off locations 204 are notional drop-off locations that a user might travel to from the pickup location 202 starting at the pickup time 203. Indeed, one of these notional drop off locations 204 may be an actual, desired drop off location that a user wishes to travel to, as will be described below with reference to FIG. 4. The pickup time 203 may be a precise time (e.g. the time the user makes a booking request, defined to the nearest minute) or it may define a time window, for example measured in a number of minutes. The notional drop-off locations 204 may be all possible destinations which the user might travel to from the pickup location 204 in a particular urban location (e.g. the geographical area the service operates in), or a subset thereof. In order to determine any such subsets, it is possible to rank the destinations from high frequency to low frequency (depending on the number of trips to those destinations) and retain the top N destinations. Notional travel times 206a, 206b, 206c . . . 206n between the pickup location 202 and the notional drop-off locations 204 are also defined. In at least one arrangement, the notional travel times 206 are calculated based on the travel (road) distance to the notional drop-off locations 204 from the pickup location 202 and the expected average road speed a service provider (driver) can expect to achieve along each of these routes. Prevailing traffic conditions—i.e., how busy the roads are between the pickup location 202 and the drop-off locations 204 in that particular time window—may also be factored in to the calculation of the notional travel times 206. The notional drop-off locations 204, and respective travel times thereto can be used in the derivation of an “index idle time” which is used in in the calculation of the lost opportunity cost, and the adjustment of a quantum (e.g. a fare) for a job starting at the pickup location 202 at a particular time to the user's preferred drop-off location.

As illustrated in FIG. 2a, for pick-up location ‘P’ 202 at pick-up time t0 203, there are “n” notional drop-off locations D1 204a, D2 204b, D3 204c . . . Dn 204n with a respective “n” notional (estimated) travel times thereto. As shown, the notional travel time 206a from pick-up location ‘P’ 202 to notional drop-off location D1 204a, is delt1, the notional travel time 206b from the pick-up location ‘P’ 202 to notional drop-off location D2 204b, is delt2, the notional travel time 206c from the pick-up location ‘P’ 202 to notional drop-off location D3 204c, is delt3, and the notional travel time 206n from the pick-up location ‘P’ 202 to notional drop-off location Dn 204n, is deltn. The chance of having any user make a service request to a drop-off location 204a-204n from pick-up location 202 is shown in percentages 208a-208n. This can also be thought of as the possibility that a driver will receive a job from pick-up location P to any of the locations D1 204a, D2 204b, D3 204c . . . Dn 204n and may be used effectively as a weighting in the calculation of the index idle time. This percentage may be calculated using the most recent historical data. In FIG. 2a, the proportion of bookings to D1 and the expected idle time at D1 are prop1 and it1 respectively, the proportion of bookings to D2 and the expected idle time at D2 are prop2 and it2, the proportion of booking to Dn and the expected idle time at Dn are probn and itn. In one exemplary arrangement, the index idle time is calculated as the sum of prop1*it1, prop2*it2, . . . and propn*itn. In this example, the chance of having a user service request to notional drop-off location D1 204a from pick-up location 202 at pick-up time 203 is 30%, the chance of having a service request to notional drop-off location D2 204b from pick-up location 202 at pick-up time 203 is 10%, the chance of having a user service request to notional drop-off location D3 204c from pick-up location 202 at pick-up time 203 is 5%, and the chance of having a user service request to notional drop-off location Dn 204n from pick-up location 202 at pick-up time 203 is 0.1%.

The notional (or estimated) drop-off time 210a at notional drop-off location D1 204a for a journey from ‘P’ 202 is t1, the notional drop-off time 210b at notional drop-off location D2 204b from ‘P’ 202 is t2, the notional drop-off time 210c at notional drop-off location D3 204c from ‘P’ 202 is t3, and the notional drop-off time 210n at notional drop-off location Dn 204n from ‘P’ 202 is tn. In other words, each of the notional travel times 206a, 206b, 206c . . . 206n are the time difference between each of the notional drop-off times 210a-210n and the pick-up time t0 203. Each notional drop-off location D1-Dn 204a-204n has a corresponding historical idle time it1-itn 212a-212n as described above. In at least one example, a corresponding revenue per second rps1-rpsn 214a-214n is derived for each of the drop-off locations 204.

These data 202, 203, 204a-204n, 206a-206n, 208a-208n, 210a-210n, 212a-210n, 214a-214n are stored in database 126 as one or more data records of historical data having the data fields as illustrated at FIG. 2b.

It should be appreciated that the communications server apparatus is configured to generate, in the one or more data records, one or more notional travel time data fields comprising data indicative of plural notional travel times to the plural notional drop-off locations using the user pick-up time and the user pick-up location.

It should be appreciated that the communications server apparatus is further configured to generate, in the one or more data records, one or more notional drop-off time data fields comprising data indicative of plural notional drop-off times at the plural notional drop-off locations from the data indicative of the plural notional travel times.

It should be appreciated that the communications server apparatus is further configured to retrieve data for historical idle time at each of the plural notional drop-off locations at the plural notional drop-off times and process the historical idle time at each of the plural notional drop-off locations at the plural notional drop-off times into data indicative of the service provider's index idle time at the plural notional drop-off locations, as will be described in greater detail below with reference to FIG. 4.

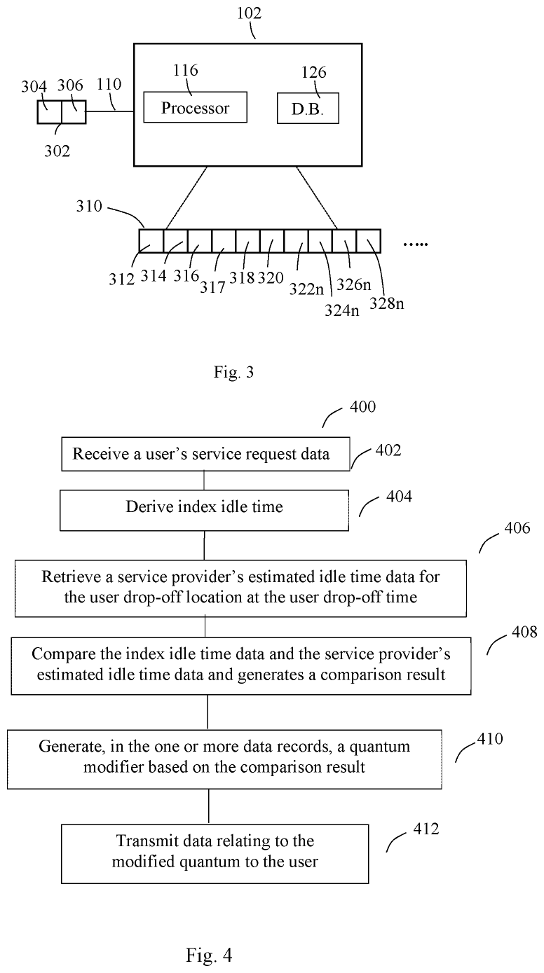

FIG. 3 is a diagram illustrating generation of one or more data records 310 comprising data fields 312-328 by communications server apparatus 102. In the example of FIG. 3, communications server apparatus 102 creates a single data record (e.g. a file) comprising the illustrated data fields (themselves comprising data representative of the respective parameters discussed herein), but it will be appreciated that communications server apparatus 102 may alternatively create more than one data record and for the data to be written into data fields of the plural data records.

Communications server apparatus 102 comprises a processor 116 and a database 126 and is configured to receive a user service request data 302 which comprises user pick-up location data 304 comprising data indicative of the pick-up location 202 and a user drop-off location data 306 comprising data indicative of the user's actual desired drop-off location, received through communications channel 110. The processor 116 is configured to record a user pick-up time 203 and record this in data field 312. The processor is configured to generate one or more data records 310 comprising an index idle time data field 314, a user drop-off time data field 316, an estimated idle time field 317, comparison data field 318, quantum modifier data field 320, notional travel time data fields 322n, notional drop-off locations data fields 324n, notional drop-off times data fields 326n, and notional idle time data fields 328n.

FIG. 4 is a flow chart illustrating an exemplary method 400 performed in a communications server apparatus 102 for deriving a quantum modifier for a quantum related to a transportation service.

A user (not shown) at pickup location P 202 (from FIG. 2a) wishes to travel to a location such as D1 204a, D2 204b, D3 204c . . . D4 204n. At 202, the user makes a service request using the user communications device 104 which is running, for example, a software app facilitating the making of the service request and which allows user communications device 104 to communicate with communications server apparatus 102 to make a service request to communications server apparatus 102 for the allocation of the service request to a service provider, for the service provider to transport the user from pickup location P 202 to the desired location, the drop-off point. The service request is transmitted from user communications device 104 through communications network 108 and communications channels 110, 112 to the input-output module 122 of the communications server apparatus 102. Communications server apparatus 102 receives and processes the user service request by processor 116 and stores data relating to the request in database 126. Such stored service request data includes at least data representative of the user pick-up location 202 and the desired drop-off location 204. The user pick-up location can be explicitly specified by the user and input at user communications device 104 or taken/read from GPS data in the user communications device 104. The user pickup time can also be included in the user service request and can be, for example, the time the user transmits a request—with the implication the user wishes to be picked up as soon as possible—or it could be a specific time in the future which the user wishes the request to be valid for, a future time to be picked up at the pickup location 202. In another arrangement, the user pick-up time is projected/estimated by the communications server apparatus 102 based on the time the user makes the service request, the pick-up location 202 and the number and location of candidate service providers in the vicinity of the user who may be able to service the user's request (i.e. the pickup time is determined based on how quickly the communications server apparatus is able to connect the user with a service provider who is able to service the user and for the service provider to travel to the pick-up location 202). Thus, the user pick-up time 203 is received at or derived by the communications server apparatus 102.

At step 404, the communications server apparatus 102 derives the index idle time at plural notional drop-off locations. Exemplary methods for calculating the index idle time follows.

Referring again to FIG. 2, it will be recalled that figure illustrates n notional drop-off locations 204. Given the pickup location P 202, the pickup time 203 and the notional travel times 206 (calculated as described above) to the respective drop-off locations 204, communications server apparatus 102 derives the notional drop-off times 210 at each of the notional drop-off locations 204. These notional drop-off times 210 are the estimated times at which the user would arrive at each of the notional drop-off locations 204 should the user travel from the pickup location P 202 starting at the pickup time 203 to each of the notional drop-off locations 204. Communications server apparatus 102 retrieves the historical idle time data recorded in database 126 for the time window in which the notional drop-off times 210 fall for each notional drop-off locations 204. Communications server apparatus 102 aggregates the historical idle times for at least some and preferably all of the notional drop-off locations 204 to form an index idle time value which is at least partly representative of what the overall idle time is for the geographical area encompassing those notional drop-off locations 204 in that it gives a smoothed value for idle time at the notional drop-off locations 204 in the geographical area.

The aggregation may take the form of calculating statistical mid-index values such as the average idle time at each of the drop-off locations 204 in the time window within which the notional drop-off times 210 fall. Alternatively, the aggregation may comprise deriving the median value of the idle times, or other values like quantiles. Communications server apparatus 102 may also apply other weighting values in the aggregation calculation, for example so that notional idle times at selected locations may influence the index idle time more.

In this respect, the index idle time can be considered a type of reference or baseline value for idle time throughout the geographical region encompassing the notional drop-off locations 204.

At step 406, the communications server apparatus 102 retrieves from database 126, the historical idle time for the actual drop-off location the user wishes to travel to at the estimated drop-off time 210 for that location. The historical idle time for the actual drop-off location at the estimated drop-off time is effectively an estimate of what the service provider's idle time will be after completion of the job, when the user has been dropped off at the actual drop-off location and the service provider is looking/waiting for the next job/booking. Therefore, it should be appreciated that the communications server apparatus is configured to retrieve idle time at the user drop-off location at the user drop-off time as the service provider's estimated idle time. This may be, for example, in the form of historical idle time data or an estimate of idle time from the hierarchical model mentioned above.

At step 408, communications server apparatus 102 performs a comparison of the index idle time as calculated at step 404 with the service provider's estimated idle time for the user drop-off location 204 at the (estimated) user drop-off time 210 as calculated at step 406. Communications server apparatus 102 generates a comparison result and, based on the comparison result derives a quantum modifier at step 410. For instance, if the estimated idle time at the actual drop-off location is higher than the index idle time, then the quantum can be adjusted accordingly, for example to increase or decrease the price of the fare for the user. That is, the communications server apparatus 102 is configured for the quantum modifier data to indicate a quantum increase if the service provider's estimated idle time is greater than the index idle time. Additionally or alternatively, the communications server apparatus 102 is configured for the quantum modifier data to indicate a quantum decrease if the service provider's estimated idle time is less than the index idle time. Further in addition or in the alternative, communications server apparatus is configured for the quantum modifier date to indicate no change in the quantum if the service provider's estimated idle time is the same as the index idle time.

After generation of the quantum modifier, the modification to the quantum may be determined. That is, the communications server apparatus is configured to derive a modified quantum data field comprising data indicative of a modified quantum based on the quantum modifier data and data indicative of an original quantum related to the service request. The modified quantum, for example, the adjusted price, may thereafter be transmitted to the user. If the user finds the modified quantum acceptable, the user has the option of accepting confirming the fare at which point, communications server apparatus 102 will invite a service provider to accept the service request, transmitting to the service provider's communications device 106 booking details, such as the user's details, like the user's identification, pick up point, the modified quantum (e.g. adjusted price) of the fare and so on. As such, and as indicated above, the service provider can be compensated for the lost opportunity he (or she) will suffer for accepting the user's request to travel to the long idle time location. Conversely, if the estimated idle time at the actual drop-off location is less than the index idle time, then the quantum can be adjusted accordingly, for example, to decrease the price of the fare for the user. While that may seem less than ideal for the service provider, the service provider is expected to be compensated alternatively, by being able to secure another booking relatively quickly since the drop-off location is in a low idle time location. Of course, other quantum adjustments are contemplated. There may be situations where it is desired that the communications server apparatus 102 increases the quantum related to service request when the estimated idle time is less than the index idle time. There may be situations where it is desired that the communications server apparatus 102 decreases the quantum related to the service request when the estimated idle time is greater than the index idle time, and so on.

The amount of the quantum modifier may be proportional to the difference between the estimated idle time and the index idle time.

When the index idle time is equal to the estimated idle time, then in this example, communications server apparatus 102 does not change the fare. Either no quantum modifier is applied, or a quantum modifier of zero is applied.

Thus, it will be appreciated that FIGS. 1 to 4 and the foregoing description illustrate and describe a communications server apparatus 102 for deriving a quantum modifier for a quantum related to a transportation service, the communications server apparatus 102 comprising a processor 116 and a memory 120, the communications server apparatus 102 being configured, under control of the processor 116, to execute instructions 120 stored in the memory 118: to receive user service request data 302 comprising data 304 indicative of a user pick-up location 203 and data 306 indicative of a user drop-off location 204, to record a user pick-up time 203 and to generate one or more data records 310 comprising: an index idle time data field 314 comprising data indicative of a service provider's index idle time at plural notional drop-off locations 204a-n; and a user drop-off time data field 316 comprising data indicative of a user drop-off time 210; to retrieve, from a database 126, data 317 indicative of a service provider's estimated idle time 212 for the user drop-off location 204 at the user drop-off time 210; to compare the data 314 indicative of the service provider's index idle time and the data 317 indicative of the service provider's estimated idle time and generate a comparison result data field 318 comprising data indicative of a comparison result; and to generate, in the one or more data records 310, a data field 320 comprising quantum modifier data indicative of the quantum modifier based on the data indicative of the comparison result.

Further, there is also provided a method 400, performed in a communications server apparatus 102 apparatus for deriving a quantum modifier for a quantum related to a transportation service, the method comprising, under control of a processor 116 of the communications server apparatus 102: receiving user service request data 302 comprising data 304 indicative of a user pick-up location 203 and data 306 indicative of a user drop-off location 204, recording a user pick-up time 203 and generating one or more data records 310 comprising: an index idle time data field 314 comprising data indicative of a service provider's index idle time at plural notional drop-off locations 204a-n; and a user drop-off time data field 316 comprising data indicative of a user drop-off time 210; retrieving, from a database 126, data indicative of a service provider's estimated idle time 212 for the user drop-off location 204 at the user drop-off time 210; comparing the data indicative of the service provider's index idle time and the data indicative of the service provider's estimated idle time and generating a comparison result data field 318 comprising data indicative of a comparison result; and generating, in the one or more data records 310, a data field 320 comprising quantum modifier data indicative of the quantum modifier based on the data indicative of the comparison result.

It should also be appreciated that a computer program product comprising instructions for implementing the method for deriving a quantum modifier for a quantum related to a transportation service is provided.

It should also be appreciated that a computer program comprising instructions for implementing the method for deriving a quantum modifier for a quantum related to a transportation service is provided.

It should also be appreciated that a non-transitory storage medium storing instructions, which when executed by a processor cause the processor to perform the method for deriving a quantum modifier for a quantum related to a transportation service.

It should also be appreciated that a communications system for deriving a quantum modifier for a quantum related to a transportation service is provided. The system comprises communications server apparatus 102, at least one user communications device 104 and communications network equipment 108, 110, 112 operable for the communications server apparatus 102 and the at least one user communications device 104 to establish communication with each other therethrough, wherein the at least one user communications device 104 comprises a first processor 128 and a first memory 130, the at least one user communications device 104 being configured, under control of the first processor 128, to execute first instructions 132 stored in the first memory 130: to transmit, to the communications server apparatus 102, user service request data 302 comprising data 304 indicative of a user pick-up location 203 and data 306 indicative of a user drop-off location 204 and wherein: the communications server apparatus 102 comprises a second processor 116 and a second memory 118, the communications server apparatus 102 being configured, under control of the second processor 116, to execute second instructions 120 stored in the second memory 118: to receive the user service request data 302, to record a user pick-up time 203 and to generate one or more data records 310 comprising: an index idle time data field 314 comprising data indicative of a service provider's index idle time at plural notional drop-off locations 214; and a user drop-off time 316 data field comprising data indicative of a user drop-off time 210; to retrieve, from a database 126, data 317 indicative of a service provider's estimated idle time 212 for the user drop-off location 204 at the user drop-off time 210; to compare the data 314 indicative of the service provider's index idle time and the data 317 indicative of the service provider's estimated idle time and generate a comparison result data field 318 comprising data indicative of a comparison result; and to generate, in the one or more data records 310, a data field 320 comprising quantum modifier data indicative of the quantum modifier based on the data indicative of the comparison result.

As noted above, implementation of the techniques disclosed herein may smooth the driver/service provider utilisation and shape the demand distributions in order to avoid or at least mitigate issues caused by extreme discrepancies in supply-demand imbalance, in the same way that techniques may be provided for, say, electrical supply-load balancing or computer processing load balancing. To give just one example in this respect, computer processing load balancing can be considered as an analogy. With this analogy, the computer server can be considered similar to one of the pick-up locations mentioned above. The computer server has limited resources (in the way that driver resources at or near a pick-up location are also limited). The computer server is connected to multiple clients (similar to the drop-off locations mentioned above) and each client will send batch requests (similar to passenger requests) to the computer server for processing. The response time to the requests can be defined as a measure of system load balancing/efficiency, similar to the idle time for the drivers mentioned above.

The response time could be censored or not censored. For example, at time t_0, the client C_1 sends a batch of requests R_c1_1, R_c1_2, R_c1_3, . . . , R_c1_n to the resource/computer server allocated to it. Some time later, for example, a few minutes later, i.e. t_1, some but not all processes have been completed. It is possible to observe the exact process durations. We know that the corresponding process times of the processes which have not been completed are longer than t_1-t_0. These observations are censored. We can use survival analysis to estimate the process time PT_c1 for this batch of requests sent out at t_0 from client C_1. Similarly, we can estimate PT_c2, PT_c3 and so on. We estimate the index process time for computer server at t_0. Next time, the allocation of resource from computer server to different clients is optimised, in order to minimize the index process time.

For use of “censored” in this context, it may be helpful to summarise the concept of time-to-event data. “Censored” data can be considered “time-to-event” data. In the idle time estimation, the “event” for each idle driver is receiving a job broadcast. In a system load balancing problem, the “event” for each request process is completion of the request. If the event happened and is observed, the time to event is not censored. If the event did not or could not happen, or the event could happen but it was not possible to observe it, the time to event is censored. In idle time estimation, if a driver waits for X minutes and then logs out of the driver app in his communications device, it means it is not possible to observe when the event will happen. So, as a result, the system may only know the driver's idle time is longer than X minutes. This is a censored record. Similarly, in system load balancing, if one assumes a request sent by a client will be completed in X min, the state-checking for all request processes will happen in Y minutes (Y<X) due to predetermined schedule or some other reasons. The event cannot be observed by state-checking. As a result, it is possible only to conclude that processing the request needs more than Y minutes. This record is also “censored”.

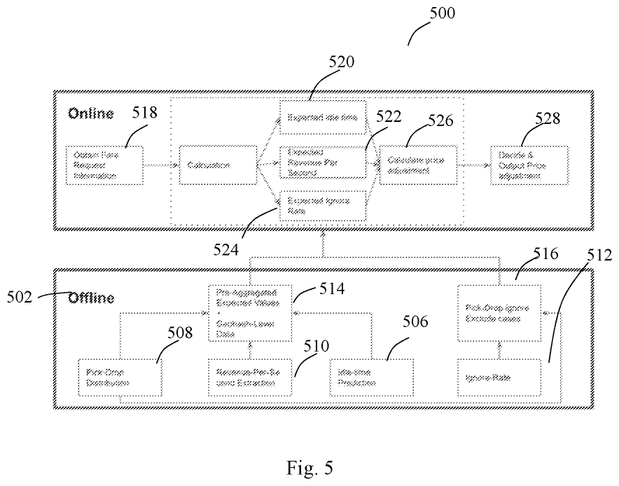

FIG. 5 is a flow diagram illustrating a method 500 for deriving a quantum modifier for a quantum related to a transportation service, the method comprising “offline” steps 502 and “online” steps 504. In this respect, the online steps are those which are executed when the user wishes to make a booking for a transport-related service. The off-line steps are those which have been carried out prior to the user making the booking request.

With further reference to FIGS. 1 to 3, in offline steps 502, the input-output module 122 of the communications server apparatus 102 receives data from the service provider communications device 106 through communications network 108 using communications channels 110 and 114. Such information includes data indicative of service providers' idle time after dropping off passengers, as described above, or sufficient information from the service provider's communications device 106 to allow the communications server apparatus 102 to derive the service providers' idle time. The data is stored in relevant locations in database 126 as historical data. As the service provider's idle time could be incomplete, ‘incomplete’ meaning that the exact time at which the service provider received a job cannot be observed, for example, when the service providers shut down the app if they do not receive jobs, it may be difficult to determine the exact idle time for service providers. When we say that an idle time record is complete, it means the driver is always online and keeps the app on after the time from dropping off the previous passenger to receiving the next job. If a driver shuts down or logs out of the app before he receives the next job, we can only conclude that this driver has not received a job before shutting down the app. If the driver did not shut down or log out of the app, he may receive a job earlier. So, the communications server apparatus may have some difficulty in determining accurately the driver's idle time if the app is not active. It is difficult to determine how much time between receiving jobs the driver is actively looking or waiting for a job, whether the driver is on, say, a break. This phenomenon can be one of the most important reasons to apply survival analysis, instead of mean, median, and other statistics, for idle time estimation.

Using the historical data, the communications server apparatus 102 conducts survival analysis on the historical data to predict and derive variable data fields such as the service provider's estimated idle time 506 after dropping off passengers for a fixed time period and fixed dropping off location, the pick-drop distribution 508, the revenue-per-second 510 from the same pick-up location, and the service provider's ignore rate 512 to broadcasted jobs to specific pick-drop location pairs. The communications server apparatus 102 then pre-aggregates the service provider's index idle time 506 after dropping off passengers, the pick-drop distribution 508, the revenue-per-second 510 into data 514 of pre-aggregated values and location level data. Location level data is a kind of description concerning the size of the locations. For example, the communications server apparatus can estimate the idle time for an entire city (i.e. at the city-level), estimate the idle time for areas in the city (at area-level), or estimate the idle time for areas at the geohash level. The communications server apparatus 102 also collates data of the pick-drop distribution 508 and data of the service provider's ignore rate 512 to data 516 of pick-drop ignore exclude cases. Data 506, 508, 510, 512, 514 and 516 are stored in the database 126 as historical data, and are saved and updated on a regular basis, for example once a day. Data 506, 508, 510, 512 may be stored in the form of a table, wherein the ‘pick_drop_distribution’ 508 denotes the approximated distributions of notional drop-off locations for the same pick-up location, the ‘idle_time_prediction’ 506 denotes the predicted idle time given location and time slot, the ‘revenue_per_second’ 510 denotes the time value of working service providers, and the ‘ignore_rate’ 512 denotes the ignore rates of bookings.

When survival analysis is conducted on service providers' idle time at the same drop-off location and fixed drop off time slot, a large number of samples may be obtained. Since the observed idle time can be incomplete or complete, prior to conducting survival analysis, the observed idle times are classified into incomplete and complete groups, and the same observations in each group are counted respectively. This means denoting the number of the same observations in each group. Before counting, each record can be stored as one row in the database. After counting, each distinct record may be one row, in order to reduce the data size. After this transformation, survival analysis is conducted. This transformation reduces data size for survival analysis and may make processing faster, and the survival model can be used to estimate data indicative of the idle time given the drop-off location and drop-off time slot.

Besides survival analysis, there are different ways to estimate the variables of interest. For example, Expectation-Maximization algorithm, machine learning models and other methods.

With further reference to FIGS. 1 to 3, in online steps 504, input-output module 122 of the communications server apparatus 102 receives a user service request data 202 at step 518 from the user communications device 104 through communications network 108 using communications channels 110, 112, whereupon it is processed by processor 116 and stored in database 126. As such, real-time service request data is obtained by the communications server apparatus 102. Such user service request data 518 includes at least a pick-up location and a drop-off location. The communications server apparatus 102 derives the user pick-up time at the user pick-up location in accordance with the principles described above. The communications server apparatus 102 uses historical data at step 514 and 516 stores this in database 126, and the real time user service request data at step 518 to calculate values of variables such as the index idle time at step 520, expected revenue per second at step 522 and expected ignore rate at step 524 if a service provider accepts a random/arbitrary job in the derived user pick-up time and the user pick-up location provided by the real-time user service request data 518. The index idle time for a random/arbitrary job in this case is not the idle time for one trip, but the index idle time of plural notional bookings starting from the same pick-up location at the same pick-up time.

The communications server apparatus 102 also derives a data field indicative of an estimated user drop-off time for the user service request, and obtains the offline estimated idle time and the estimated revenue per second at the user drop-off location and the estimated user drop-off time from the historical data in the database 126. When the estimated idle time for a fixed drop-off location and time slot is estimated, the idle time estimates may jump due to time shifts or location shifts, since the estimation can be sparse over an area or a time period. Gaussian kernel, temporal and spatial smoothing of the estimated idle time may be conducted on the estimated idle time estimates. This transformation may result in the idle time estimates not jumping due to time shifts or location shifts.

The communications server apparatus 102 then compares the data field indicative of the service provider's index idle time for a random/arbitrary trip starting from the same pick-up location at the same pick-up time, and the data field indicative of the service provider's estimated idle time to generate a comparison result and generates in the one or more data records, quantum modifier data at step 526 based on the comparison result. As noted above, this quantum modifier is an adjuster in respect of a quantum for the transportation service. In one arrangement, it is a price adjuster, a variation—a discount or a surcharge—on the price of the ride.

If the service provider's estimated idle time is greater than the service provider's index idle time, the quantum modifier data may indicate a quantum increase. If the service provider's estimated idle time is less than the service provider's index idle time, the quantum modifier data may indicate a quantum decrease. If the service provider's estimated idle time is the same as the service provider's index idle time, the quantum modifier data may indicate no change to the quantum.

As such, if the service provider's estimated idle time is greater than the service provider's index idle time at step 520, there will be a surcharge on the original fee.

If the service provider's estimated idle time is less than the service provider's index idle time at step 520, there will be a discount on the original fee.

If the service provider's estimated idle time is the same as the service provider's index idle time at step 520, the original fee will remain the same.

A model to estimate the “time value” for the driver may also be provided. The “time value” means how much a service provider can earn if the service provider is not idle for the unit time. Both surcharge and discount may be calculated with the time value and the difference between trip idle time and the index idle time.

In some instances, use of the time value in the calculation of the quantum modifier—for example, calculation of a surcharge or a discount—may be useful. For instances, in some implementations, communications server apparatus 102 is configured to determine the value of the quantum modifier as being proportional to the difference between trip idle time and index idle time. When the quantum modifier is calculated as a surcharge or a discount, this will be measured in a currency unit (e.g. a dollar), and the difference between the trip idle time and the index idle time will be measured in time units (e.g. seconds). Thus, communications server apparatus 102 may use the time value to help transfer the time difference to a monetary difference. The time value determines how large the surcharge or discount could be. The “time value” may be calculated in a simple way by, for example, using the ratio between the original fare and trip durations as the time value. Given a fixed pick-up geohash and time window, communications server apparatus 102 can calculate the ratios mentioned above for the trips to different locations, and then use the averaged ratio as the time value for the drivers becoming idle in that geohash. There are several benefits which may be realised by communications server apparatus 102 calculating the time value in this way. Firstly, it may be preferable not to have very different time value when driver is doing a job or is idle and waiting for job. Secondly, the techniques disclosed herein may be adoptive for different pricing strategies, for example, the price is linear or nonlinear function of distance, the price is linear or nonlinear function of distance, the price is dynamic and surged and so on. Of course, there could be different “time value” models.

Since the index idle time in a pick-up location is the index of idle times of plural notional trips starting from that pick-up location, the sum of quantum increases (e.g. surcharges) is approximately equal to the sum of quantum decreases (e.g. discounts) for trips starting from the same pick-up location. For example, when service providers receive jobs in the same pick-up location, some service providers may receive jobs to a relatively worse destination where they may have longer idle times after dropping off passengers. The quantum (e.g. price) of these jobs would generally be higher considering the time value of drivers' idle time. In contrast, other drivers may receive jobs to relatively better drop-off locations with lower idle times. Accordingly, the, for example, prices would be lower. Both the surcharge and the discount on the original fee may be proportional to the difference between the estimated idle time and index idle time and revenue per second. Generally, the discounts occur with surcharges for the trips starting from the same pick-up location. In this way, service providers may be provided with fair service requests, and may ensure that jobs sent to service providers are equally valued, incorporating the idle time after the completion of the service request. This may also encourage trips to drop off locations with short idle times, increasing the efficiency and utilisation of service providers.

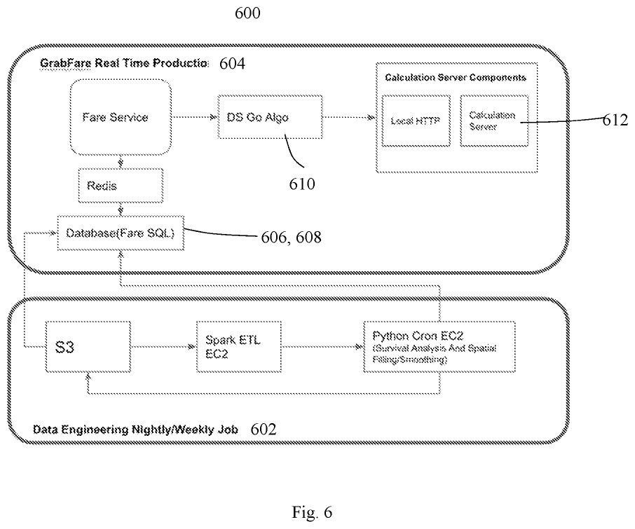

FIG. 6 is a diagram illustrating how data for deriving a quantum modifier for a transport-related service is transferred in an exemplary system 600. In the following discussion, certain detailed components and processes are identified such as S3, Spark, Redis and other system components. These are not to be considered as limiting, and other components/processes of an equivalent technical and/or functional nature can be substituted for these.

The system consists of two parts:

1. Data Engineering Nightly/Weekly Job 602

The Data Engineering ETL/Survival Analysis will run in a batch process, for example at night, perhaps every night (when there is low service load) and perform the following steps:
A Spark ETL job will run to collect the historical data, for example, the raw idle time records, the pick-up/drop-off distribution for each location such as a geohash and time_window, the revenue-per-unit time estimates for each geohash and time_window, the estimated travel-time for each geohash and time_window, the ignore-rate each geohash-geohash pair and time_window.
All of the data can be written into database S3, and all except the raw idle times may be written in database such as a MySQL database S4.
Following the above step, a python cron job will run on an EC2 instance (or multiple) to perform survival analysis on the raw idle time records, then sparsity filling and then spatial smoothing in order to determine these estimates. The result of this will be written both in to the MySQL database S4 and S3.

2. Fare Production System 604

The Fare service will handle the following:
Data stored in the MySQL database S4 may be cached into Redis database S5 when (e.g. every time) new aggregated data is made available (by the Data Engineering job above).
The above populates two tables of information: The Geohash-Geohash-Time table (pickup-dropoff distribution and travel times) 606; The Geohash-Time table (revenue per second and idle time estimates) 608 stored in, but shown separately from, Redis database S5 for the sake of clarity only.

When a fare is requested, the Fare Service 604 will read the information about the job and in turn
Get the pick-up/drop-off distribution (from the Geohash-Geohash-Time table 606 stored in Redis database S5) and estimated travel times for the requesting geohash (from the table of Geohash-Geohash-Time 606).
Determine expected drop off time at each geohash in the pick-up/drop-off distribution.
Gather the trip and index idle time, revenue per second and ignore-rates for the correct time periods for these geohashes from the Geohash-Time table 608. Pass this information to the DS Go Algo 610 which then calculates the surcharge/discount.
The DS Go Algo is a module which may also call a Calculation Server instance 612 in order to incorporate some real time signals and apply more complex models to revise the surcharge/discount.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server apparatus for deriving a quantum modifier for a quantum related to a transportation service, the communications server apparatus comprising a processor and a memory, and being configured, under control of the processor to execute instructions in the memory:
to receive user service request data comprising data indicative of a user pick-up location and data indicative of a user drop-off location, to record a user pick-up time and to generate one or more data records comprising:
an index idle time data field comprising data indicative of an index idle time for plural notional drop-off locations; and
a user drop-off time data field comprising data indicative of a user drop-off time;
to retrieve, from a database, data indicative of a service provider's estimated idle time for the user drop-off location at the user drop-off time;
to compare the data indicative of the index idle time and the data indicative of the service provider's estimated idle time and generate a comparison result data field comprising data indicative of a comparison result; and
to generate, in the one or more data records, a data field comprising quantum modifier data indicative of the quantum modifier based on the data indicative of the comparison result.

2. The communications server apparatus of claim 1, configured to generate, in the one or more data records, one or more notional travel time data fields comprising data indicative of plural notional travel times to the plural notional drop-off locations using the user pick-up time and the user pick-up location.

3. The communications server apparatus of claim 2, configured to generate, in the one or more data records, one or more notional drop-off time data fields comprising data indicative of plural notional drop-off times at the plural notional drop-off locations from the data indicative of the plural notional travel times.

4. The communications server apparatus of claim 3, further configured to retrieve data for historical idle time at each of the plural notional drop-off locations at the plural notional drop-off times and process the historical idle time at each of the plural notional drop-off locations at the plural notional drop-off times into data indicative of the service provider's index idle time at the plural notional drop-off locations.

5. The communications server apparatus of claim 1, configured to retrieve idle time at the user drop-off location at the user drop-off time as the service provider's estimated idle time.

6. The communications server apparatus of claim 1, configured for the quantum modifier data to indicate a quantum increase if the service provider's estimated idle time is greater than the index idle time.

7. The communications server apparatus of claim 1, configured for the quantum modifier data to indicate a quantum decrease if the service provider's estimated idle time is less than the index idle time.

8. The communications server apparatus of claim 1, configured for the quantum modifier data to indicate no change in the quantum if the service provider's estimated idle time is the same as the index idle time.

9. The communications server apparatus of claim 1, wherein the communications server apparatus is configured to derive a modified quantum data field comprising data indicative of a modified quantum based on the quantum modifier data and data indicative of an original quantum related to the service request.

10. A method, performed in a communications server apparatus for deriving a quantum modifier for a quantum related to a transportation service, the method comprising, under control of a processor of the communications server apparatus:
receiving user service request data comprising data indicative of a user pick-up location and data indicative of a user drop-off location, recording a user pick-up time and generating one or more data records comprising:
an index idle time data field comprising data indicative of a service provider's index idle time at plural notional drop-off locations; and
a user drop-off time data field comprising data indicative of a user drop-off time;
retrieving, from a database, data indicative of a service provider's estimated idle time for the user drop-off location at the user drop-off time;
comparing the data indicative of the service provider's index idle time and the data indicative of the service provider's estimated idle time and generating a comparison result data field comprising data indicative of a comparison result; and
generating, in the one or more data records, a data field comprising quantum modifier data indicative of the quantum modifier based on the data indicative of the comparison result.

11-12. (canceled)

13. A non-transitory storage medium storing instructions, which, when executed by a processor, cause the processor to perform the method of claim 10.

14. A communications system for deriving a quantum modifier for a quantum related to a transportation service comprising a communications server apparatus, at least one user communications device and communications network equipment operable for the communications server apparatus and the at least one user communications device to establish communication with each other therethrough, wherein the at least one user communications device comprises a first processor and a first memory, the at least one user communications device being configured, under control of the first processor, to execute first instructions stored in the first memory:
to transmit, to the communications server apparatus, user service request data comprising data indicative of a user pick-up location and data indicative of a user drop-off location and wherein:
the communications server apparatus comprises a second processor and a second memory, the communications server apparatus being configured, under control of the second processor, to execute second instructions stored in the second memory:
to receive the user service request data, to record a user pick-up time and to generate one or more data records comprising:
an index idle time data field comprising data indicative of a service provider's index idle time at plural notional drop-off locations; and
a user drop-off time data field comprising data indicative of a user drop-off time;
to retrieve, from a database, data indicative of a service provider's estimated idle time for the user drop-off location at the user drop-off time;
to compare the data indicative of the service provider's index idle time and the data indicative of the service provider's estimated idle time and generate a comparison result data field comprising data indicative of a comparison result; and
to generate, in the one or more data records, a data field comprising quantum modifier data indicative of the quantum modifier based on the data indicative of the comparison result.
